(19) United States
(12) Patent Application Publication
(10) Pub. No.: US 2025/0137172 A1
(43) Pub. Date: May 1, 2025

(54) POLYLACTIC ACID HIGH-STRENGTH LONG FIBER USING NATURAL DYE PIGMENTS AND ITS MANUFACTURING METHOD

(71) Applicant: VISIONWORLD CO., LTD., Seoul (KR)

(72) Inventor: Yoon Seok JANG, Gyeonggi-do (KR)

(21) Appl. No.: 18/505,234

(22) Filed: Nov. 9, 2023

(30) Foreign Application Priority Data
Oct. 31, 2023 (KR) 10-2023-0148447

(51) Int. Cl. D01F 6/62; C08J 3/22; C08K 5/00; D01D 5/084; D01F 1/06

(52) U.S. Cl. CPC D01F 6/625; C08J 3/226; C08K 5/0041; D01D 5/084; D01F 1/06; C08J 2367/04; D10B 2331/041; D10B 2401/063; D10B 2401/12; D10B 2401/20

(57) ABSTRACT

A high-strength long fiber to which a natural-derived dye is applied and its manufacturing method. The method includes a first step of compounding a masterbatch by dispersing natural dye into in polylactic acid (PLA); a second step of spinning a fiber from the master batch in a high-speed melt spinning device; and a third step of heat stretching the spun fiber in a multi-stage stretching device. The present disclosure enables optimizing the color expression of the polylactic acid long fiber by applying a natural dye in the process of high-speed melt spinning of the long fiber.

### CROSS-REFERENCE TO RELATED APPLICATION

This application claims priority to and the benefit of Korean patent application no. 10-2023-0148447, filed on Oct. 31, 2023, the disclosure of which is incorporated herein by reference in its entirety.

### TECHNICAL FIELD

The present disclosure relates to biodegradable polylactic acid high-strength long fiber and methods of manufacturing the same by applying natural dye and pigments, more specifically, an environmentally friendly biodegradable polylactic acid high-strength long fiber and methods for manufacturing the same that enable the vivid color of the yarn by adding natural dye pigments in the process of high-speed melting and spinning of the polylactic acid.

### BACKGROUND

Textiles are divided into natural fibers and chemical (man-made) fibers. Natural fibers include vegetable fibers such as cotton, hemp, manila hemp, sisal, and the like; animal fibers such as silk, hair fibers; and mineral fibers such as asbestos. In addition, chemical fibers include recycled fibers such as rayon and acetate; synthetic fibers such as nylon, polyester, polyurethane, acrylic; and inorganic fibers such as organometals, metal fibers, and ceramics.

Dyes can be divided into natural dyes and synthetic dyes, and natural dyes are obtained from nature and are divided into animal dyes, vegetable dyes, mineral dyes, and the like, depending on how they are collected.

Currently, the method of dyeing using natural dyes using polyester, which is the most popular material, is mainly researched, and although it is an eco-friendly technology that mainly uses recycled PET yarn and uses low-emission natural dyes compared to dispersed dyes, the problem of final disposal still remains due to the concept of upcycling.

Therefore, the direction of the development of dyeing technology using eco-friendly textile materials that do not cause environmental problems is being further considered, and eco-friendly textile materials referred to here can be defined as fibers that do not pose an environmental threat and have biomass and biodegradable functions.

For example, biodegradable fibers such as polylactic acid (PLA) and polybuthylene succinate (PBS) are biodegradable to more than 90% within 6 months with water and carbon dioxide under compost conditions and return to nature, and are recently proposed as a solution for realizing carbon neutrality in the textile and fashion industry. In particular, in line with the recent trend of environmental regulations related to microplastics, PLA, an eco-friendly biodegradable polymer, is attracting a lot of attention around the world.

Ordinary biodegradable PLA plastics have the advantage of degrading in 6 to 24 months. As a result, it is widely used in the environmentally friendly food packaging industry and consumable tableware, and is used to make agricultural films, electronics, automotive parts, products manufactured by injection molding processes, and textiles. Due to consumers' growing environmental awareness and strict government regulations, the demand for green products continues to grow, which is expected to drive high demand in the future.

Korean Patent No. 10-2459991 discloses a core-sheath-type composite fiber manufacturing method consisting of a first composite resin in the core part and a second mixed resin in the sheath part. The method comprises step S1, in which the first blended resin comprises PCL (Polycaprolactone) resin and biodegradable polyester resin and the second composite resin comprises cellulose fatty acid polyester resin and polylactic acid resin are each inputted into separate extruders and melted in a temperature range of 200 to 230° C.; step S2 of adding antioxidants to the first melted mixed resin, and adding plasticizers and natural extracts to the melted second mixed resin; step S3 of spinning the first and second mixed resins into a core-sys type using a composite spinning device; and step S4 of stretching the spinning composite fibers. In step S2, the natural extract is mixed with the PLGA resin after cooling the molten second mixed resin to 150 to 180° C., and the natural extract is characterized by the bokyeong and peppermint extract, and presented an eco-friendly biodegradable composite fiber manufacturing method.

In addition, the Korean Patent Application Publication No. 2000-0061141 discloses a method for the manufacture of polyamide yarn consisting of a process of dispersing a colorant representing gas-phase oxidized carbon black or various colored colors into a resin with an ester bond or an amide bond and adding a coloring resin that represents the color by adding 0.1 wt % to 10 wt % of the coloring resin to produce unstretched, partially elongated, and stretched yarn after uniform mixing and drying. In addition, in order to express the desired color and brightness of the fabric without going through the dyeing process in the manufacture of the fabric, a master batch chip containing particles containing color is inserted during spinning, and a method of manufacturing polyamide raw yarn that does not differ in physical properties from general polyamide yarn was presented.

### BRIEF SUMMARY

One purpose of the present disclosure is to provide a method for the production of biodegradable polylactic acid high-strength long fibers using natural dyes that minimize the use of dyes, water and energy as well as to enable the expression of the vivid color of the yarn with a minimum process by establishing various process conditions that can prevent the problem of re-agglomeration of natural dyes by enabling even dispersion of dyes in the yarn in the manufacture of high-strength long fibers capable of realizing a predetermined color using polylactic acid fiber, which is an eco-friendly textile material, and natural dyes.

In addition, another purpose of the present disclosure is to establish the various process conditions to provide a polylactic acid high-strength long fiber that can satisfy the required physical properties even by using eco-friendly fibers and natural dyes, and can realize a variety of colors.

In one aspect, a biodegradable polylactic acid high-strength long fiber with a natural dye applied is provided, wherein biodegradable polylactic acid high-strength long fiber is dyed in a spinning process by adding a masterbatch that is produced by adding the natural dye into a polylactic acid.

A pure polylactic acid may be added in the spinning process.

A concentration of the natural dye may be 1% to 5% by weight of a total polylactic acid.

An average particle size of the natural dye may be 3.0 μm or less.

A polylactic acid resin may be maintained below 100 ppm in the master batch.

The natural dye may be one or a combination of bio indigo from an indigo extract, pomegranate, bee from center of the thorn tree, leafy vegetable extract, carel being a fruit of a Gaja tree, rennet from pear tree, rubia from a root and underground stem of a rake stem, Nimbus, or Yeliona from hydrangea in bright yellow color.

In another aspect, a method of manufacturing a biodegradable polylactic acid high-strength long fiber includes a first step of compounding a masterbatch by dispersing natural dye into the polylactic acid (PLA); a second step of spinning a fiber from the master batch in a high-speed melt spinning device; and a third step of heat stretching the spun fiber in a multi-stage stretching device.

The natural dye may be compounded in the first step at a concentration of 5 to 15% by weight.

A twin-screw extruder may be used in the first step of compounding the master batch.

The second step may further comprise adding pure polylactic acid so as to dilute the concentration of the natural dye into 1 to 5% by weight with respect to the total weight of the polylactic acid.

Stretching conditions in the multi-stage stretching device may include a stretching ratio of 1.5 to 3 times, a speed of 2,000˜5,000 mpm/min, and a temperature 60 to 150° C.

The method may further include an annealing process at a temperature of 90 to 140° C. after the heat stretching.

According to the present disclosure, in order to optimize the color expression of polylactic acid long fibers by applying natural dyes in the process of high-speed melt spinning, the twin-screw compounding process and the high-speed melt spinning process can be optimized to minimize the resources required for printing and dyeing processes after weaving, and the strength of the fiber can be improved through the multi-stage hot drawing process to maximize the mechanical performance.

In addition, in the present disclosure, a natural dye that does not contain chemical components is included in polylactic acid, which is a biodegradable material, and by producing fibers, it is harmless to the human body, and it has an environmentally advantageous effect because it is finally biodegraded and does not have the problem of disposal.

### BRIEF DESCRIPTIONS OF THE DRAWINGS

FIG. 1 illustrates an example masterbatch manufacturing apparatus for compounding dyes into a masterbatch dispersed in PLA according to one embodiment of the present disclosure.

FIG. 2 illustrates an example high-speed melt spinning device for spinning the masterbatch into the fiber.

FIG. 3 illustrates an example multistage stretcher that heat-stretches the spun fiber.

FIG. 4 is an example flow diagram showing a method for manufacturing biodegradable polylactic acid high-strength long fibers by applying a natural dye according to one embodiment of the present disclosure.

FIG. 5A shows example pictures of the natural dyes used in each of the embodiments of the present disclosure.

FIG. 5B shows example Scanning Electron Microscope (SEM) images of a side and a cross section of the fiber.

FIG. 6 is an example experimental chart for showing the changes in the tensile strengths of PLA long fibers produced according to Examples 5˜7 with various stretching rates.

FIG. 7 is an example chart showing the change in tensile strengths of high-strength long fibers using various natural dyes of Examples 8˜11.

FIG. 8 is an example SEM image analysis of a filament with a natural dye with different stretching ratios.

FIG. 9 shows the TGA analysis results of long fibers according to the types of natural dyes.

FIG. 10 is an example picture of PLA long fibers manufactured using rubia as a natural dye.

### DETAILED DESCRIPTION

The present disclosure is described in more detail below.

The terms used in this specification are used to describe specific embodiments and are not intended to limit the invention.

As used herein, singular forms may include plural forms unless the context clearly indicates a different case. In addition, as used herein, “comprise” and/or “comprising” identifies the existence of the said shapes, numbers, steps, motions, absences, elements and/or groups thereof, and does not exclude the existence or addition of one or more other shapes, numbers, motions, absences, elements and/or groups.

The present disclosure relates to biodegradable polylactic acid high-strength long fibers which are manufactured by applying naturally produced dyes and methods for manufacturing the same.

The terms ‘a natural dye,’ and ‘a naturally derivative dye’ in the present disclosure are in contrast to an artificial dye and can be understood to include any dyes extracted from natural products, such as animal dyes, vegetable dyes, and mineral dyes.

The biodegradable polylactic acid high-strength long fibers to which a natural dye is applied according to the present disclosure is characterized by the addition of a natural dye to polylactic acid, and the masterbatch produced by applying the natural dye in the spinning process.

Polylactic acid (PLA) resin used in the present disclosure refers to a biodegradable resin mainly made from plants such as corn and sugarcane, and is in the largest production of eco-friendly (biodegradable) polymer compounds in the world. Polylactic acid resin is widely studied in materials engineering by adding substances that are not harmful to the human body or by itself, and its use is very wide-ranging, such as being used as a scaffold in tissue engineering in medicine, and it is a biodegradable resin that possesses some characteristics from a general purpose commercial point of view, not in a special field such as medicine.

The polylactic acid used in the present disclosure may use a polylactic acid monopolymer or a copolymer with polylactic acid as the main component. It is desirable that the polylactic acid is kept below 100 ppm in the resin through the vacuum drying process so that the desired level of the spinning process can be carried out smoothly.

In addition, in the present disclosure, it is possible to achieve a predetermined dyeing effect by evenly dispersing the natural dye in the conventional yarn, and to solve the problem of reagglomeration, it is desirable to use a method of adding a natural dye to the polylactic acid to produce a master batch. Then, the method comprises using the master batch in the spinning process, and also adding pure polylactic acid to reach the final concentration of the natural dye.

In other words, the manufacturing method of biodegradable polylactic acid high-strength long fiber by applying a natural dye according to the present disclosure can be achieved through a process comprising the first step of compounding the natural-derived dye to a master batch dispersed in PLA, the second step of radiating the master batch in a high-speed melting spinning device, and the third step of thermal stretching the spun fiber in a multi-stage stretching device.

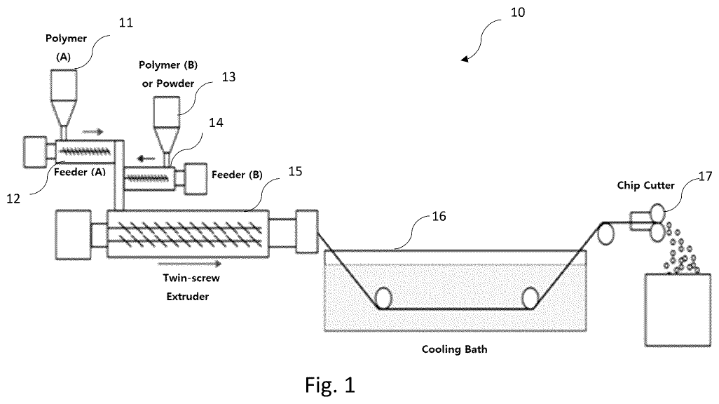

First of all, the first step is a compounding process, in which the natural dye is dispersed in PLA, and then the dyed PLA is processed into a master batch. In specific, the polylactic acid (corresponding to Polymer A in FIG. 1) is supplied through the inlet 11 and passes through single screw 12, as illustrated in FIG. 1. On the other hand, the natural dye (corresponding to Polymer B or Powder in FIG. 1) is supplied through different inlet 13 and passes through single screw 14. The natural dye and PLA are mixed with each other as they pass through twin-screw extruder 15 so that the natural dye is evenly dispersed into the polylactic acid. After that, the dyed PLA is cooled through cooling bath 16 and is chopped by chip cutter 17 to produce a masterbatch.

The natural dyes used in the disclosure may be bio indigo from an indigo extract with a dark blue color), pomegranate (mallow with a yellow, khaki, or gray color), Bee extracted from the center of the bramble tree, brown in color), leafy vegetable extract (having green color), Karrel extracted from the fruit of the Gaza tree, having yellow, khaki, or gray color), Rennet (ivory, bright yellow, or gray in color), Rubia extracted from the root and underground stem of the rake, having red, pink, or orange color, Nimbus extracted from a bunch of nymbus, having red or purple color, Yeliona extracted from hydrangea, having bright yellow color, or a combination of two or more.

In the present disclosure, it is desirable to manage the average particle size at a level of 3.0 μm or less for uniform dispersion of the natural dyes in the manufacture of the master batch so that the compounding process proceeds without the phenomenon of re-agglomeration, and it is desirable to prevent any problems during subsequent filament spinning.

In addition, in the compounding process, it is desirable to prepare a relatively high concentration so that the content of natural dyes in the master batch is 5˜15% by weight.

The second step of manufacturing biodegradable polylactic acid high-strength long fibers by using a natural dye is the process of spinning fiber from the master batch in the high-speed melting spinning device 20.

At this second step, it is desirable in terms of spinning yield and cost reduction to add pure polylactic acid to the masterbatch produced in the first step. The content of pure polylactic acid added at this time is adjusted so that the concentration of natural dyes on the total polylactic acid is 1 to 5% by weight. If the concentration of the natural dye is less than 1% by weight for the total polylactic acid, there can be a problem that the color expression is not sufficient; but if it exceeds 5% by weight, the dye used may be not evenly dispersed, which causes a problem with color expression, which is undesirable.

In the step of spinning fibers, the masterbatch made of PLA-natural dyes prepared in the first stage and the pure PLA are fed into the inlet 21 and is extruded through the main feeder 22, and then is discharged under pressure from nozzle 24 by the pressure of the gear pump 23. As an example, the temperature of the main feeder 22 is 190° C., and nozzle 24 is a single nozzle with 24 holes, each hole having a dimeter of 0.25 mm, and a length/diameter (L/D) ratio of the nozzle 24 is 2. The spinning output is 0.46 g/min, for example. The spun fibers are wound in a high-speed winder 27 through take-up roller 25 and drawing roller 26.

The initial winding speed is in the range of 1˜3 km/min, after which winding may be carried out in the range of 2˜5 km/min.

Finally, the third step of manufacturing biodegradable polylactic acid high-strength long fibers is the process of thermal stretching of the spun fibers in multi-stage stretching machine 32. At this step, it is desirable to perform stretching under the conditions of a stretching rate of 1.5 to 3 times, a rolling speed of 2,000˜5,000 mpm/min, and a temperature of 60 to 150° C.

In the case of the stretching rate being less than 1.5, the improvement in the strength of the manufactured long fiber is insufficient and has a uniform thickness or the long fiber diameter is thick, which is undesirable, and in the case of the stretching rate exceeding 3 times, the strength of the long fiber is excellent, but the diameter of the fiber is too reduced and is undesirable.

It is desirable that the strength of the polylactic acid long fiber prepared in accordance with the present disclosure is 4 to 6 g/denier as the specific strength (strength-to-weight), and that the strength can be realized at a similar level even after the application of natural dyes.

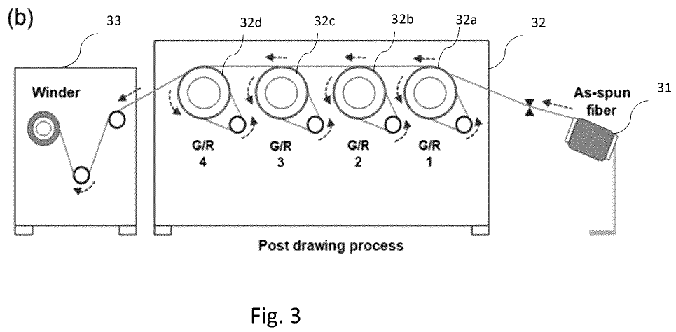

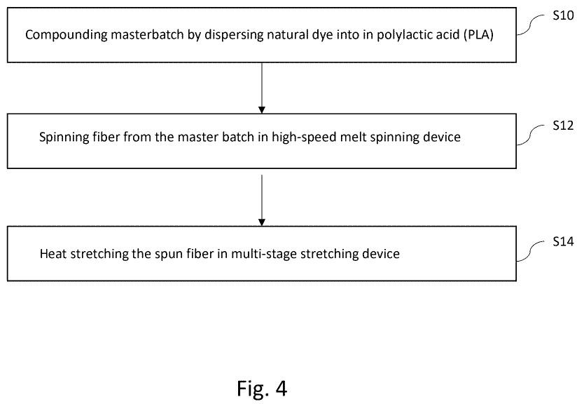

In the stretching process of the present disclosure, it is desirable to use a multi-stage stretching machine 32 as shown in FIG. 3. In each of the stretching stages, which are gear-ratio (G/R) 1 32a, G/R 2 32b, G/R 3 32c, G/R 4 32d, an Infrared (IR) heater and/or a contact & non-contact heater may be applied individually or in combination so that each stretching stage can have different optimized stretching ratios and heat treatment conditions. Through this, while controlling the stretching conditions, the final manufactured fiber has an optimal strength with natural dyes applied, and the fibers with a uniform thickness can be formed after the stretching process.

It is obvious that the stretching ratio and heat treatment conditions of each stage can be made in accordance with the above thermal stretching conditions, and can be adjusted to the conditions that meet the prescribed purpose.

In addition, according to the present disclosure, it is possible to further enhance the strength of a high-strength long fiber utilizing a natural dye prepared by an annealing process at an additional temperature of 90° C. to 140° C. after the thermal stretching.

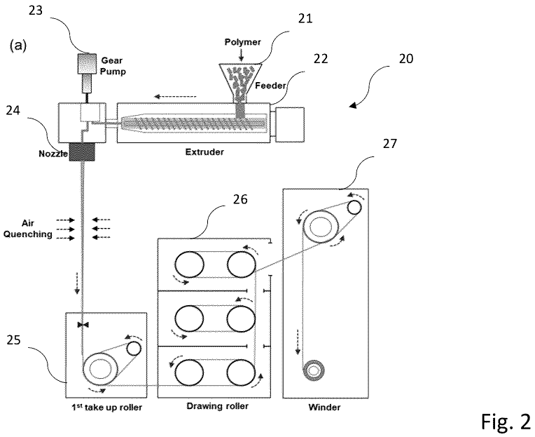

Hereinafter, the several embodiments of the high-strength long fiber manufactured through the three steps illustrated in FIGS. 1 to 3 shall be described. The following embodiments are intended to illustrate the present disclosure only, and the scope of the present disclosure should not be construed as being limited by these embodiments. In addition, in the following embodiments, it is obvious to one of ordinary skill that a similar effect can be achieved in the case of the use of equivalent compositions.

Examples 1˜4 are the high-strength long fiber manufacturing methods by applying natural dyes with different concentrations.

In the compounding process illustrated in FIG. 1, polylactic acid (PLA), which is a 6025D grade of Natureworks®, having a moisture content of 10 ppm), and Rubia, a product of Control Union® of the Netherlands, having an average particle size of 2.21 μm as a natural dye were added to different inlets 11, 13. As a result, a masterbatch with a Rubia concentration of 10% by weight is manufactured after being mixed in twin-screw extruder 15.

In the spinning process, the masterbatch and pure polylactic acid are fed separately, into different inlets, so that the concentration of Rubia natural dye is contains 1 wt % (Example 1), 1.5 wt % (Example 2), 3 wt % (Example 3) and 5 wt % (Example 4) respectively, and then is spun into a long fiber by the following process.

The PLA polymers are spun into a long fiber in melt spinning device 20 with high-speed winder 27. As an example, the temperature of the main feeder 22 is 190° C., and the nozzle 24 has a single nozzle. Nozzle 24 may have 24 holes, each hole having a diameter of 0.25 mm, and the length-diameter ratio (L/D) of the nozzle may be 2.

In one embodiment, the spinning discharge amount is 0.46 g/min, with an initial winding speed in the range of 1˜3 km/min, and the subsequent winding speed in the winder 27 is in the range of 2˜5 km/min. Using four-stage stretcher 32 shown in FIG. 3, stretching is performed in the G/R-1 32a stage under the following example conditions: a speed of 100 mpm, a stretching temperature 75° C., the stretching rate of 3 times, and a heat fixation temperature of 90° C.; and the same conditions were applied to the other stretching stages 32b to 32d to produce a long fiber with 2 deniers.

Examples 5˜7 are the high-strength long fiber manufacturing methods with different stretching ratios.

In the case of the manufacture of high-strength long fibers applied with a natural dye according to the embodiment 4, the stretching ratios in multi-stage stretching machine 32 were set as 1.5 (Example 5), 2.0 (Example 6), and 2.5 times (Example 7), respectively.

Examples 8˜11 are the high-strength long fiber manufacturing methods using various kinds of natural dyes.

Instead of rubia 53 used as a natural dye in the embodiment 1, Indigo 51 (Example 8), pomegranate 52 (or MALLOW, Example 9), Yeliona 54 (Example 10), or rennet 55 (Example 11) is used to produce high-strength long fibers by the same manufacturing process.

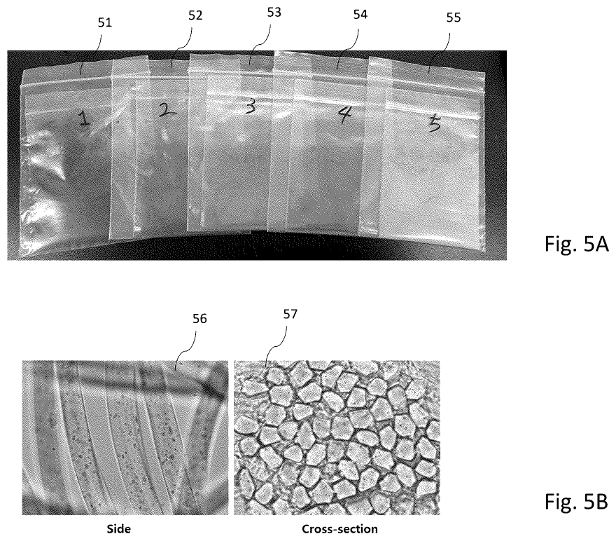

The photos of the different natural dyes 51, 52, 53, 54, 55 used in Examples 1 and 8-11 are shown in FIG. 5A.

In Experiment 1, the dispersibility of natural dye in PLA long fibers was examined.

In order to check whether the natural dye is well dispersed in the PLA long fiber manufactured in accordance with Embodiment 4, the side and cross-section of the fiber were measured and confirmed using a scanning electron microscope (SEM), and its side SEM image 57 and cross-sectional SEM image 58 are shown in FIG. 5B.

Referring to FIG. 5B, it is observed that the natural dyes are stably dispersed in a uniform phase in the interior and surface of PLA long fibers.

In Experiment 2, the tensile strengths of PLA long fibers according to the stretching ratios and the type of natural dye were examined.

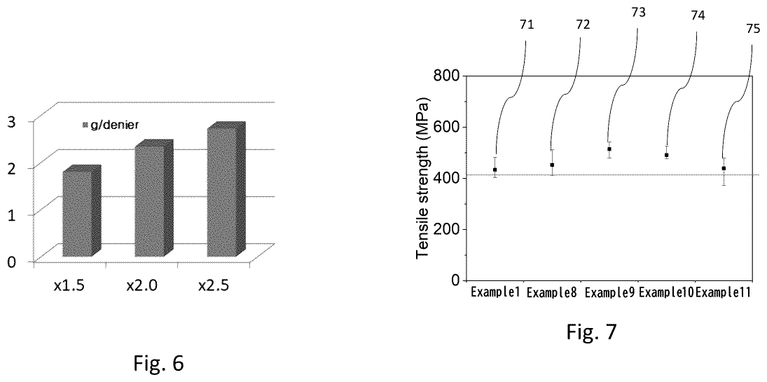

Specifically, in order to measure the changes in the tensile strength of PLA long fibers that were manufactured in Examples 5˜7 by varying stretching ratios; and to measure the changes in the tensile strength of high-strength long fibers manufactured using various natural dyes in Examples 8˜11, the strength of a single fiber was measured by a universal testing machine (Textechno, Favimat, Germany) in accordance with ASTM D2256. At this time, at least 10 specimens with measuring lengths and velocities of 20 mm and 20 mm/min were measured to obtain the results, which are shown in FIGS. 6 to 7, respectively.

Referring to FIG. 6, it is observed that the strength (the y-axis) is improved as the stretching (the x-axis) is increased. In addition, the change in the tensile strength of high-strength long fibers using various natural dyes of Example 8˜11 was shown in FIG. 7. Referring to FIG. 7, it was observed that the tensile strengths 71, 71, 72, 73, 74, and 75 of the high-strength long fibers of Example 1 and 8˜11 exhibit excellent physical properties between 400 MPa and 500 Mpa.

In Experiment 3, it was observed that the fiber shape was confirmed according to the stretching of PLA long fibers to which natural dyes were applied.

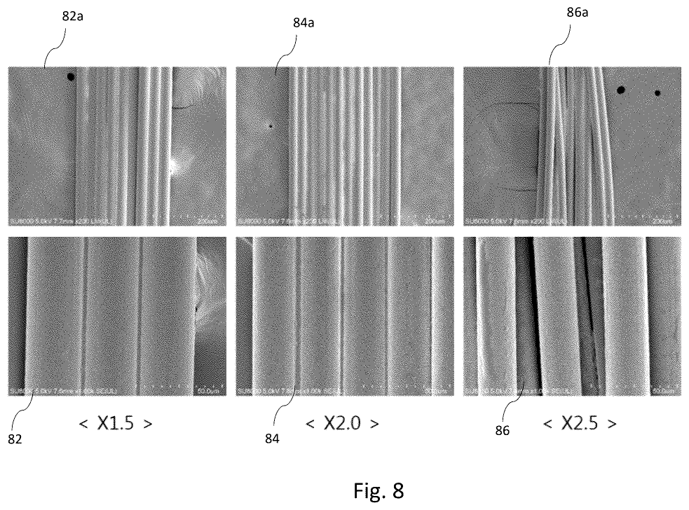

FE-SEM image analysis according to the stretching of PLA long fiber manufactured in Examples 5˜7 was performed, and the result is shown in FIG. 8.

Referring to FIG. 8, in the SEM image analysis of the filaments to which a natural dye is applied while increasing the stretching ratios, it was observed that the fibers 82 (an enlarged image of 82a), 84 (an enlarged image of 84a), 86 (an enlarged image of 86a) with uniform thicknesses were formed in each of Embodiments 5, 6, and 7 with stretching ratios 1.5, 2.0 and 2.5, respectively, even after the application of the stretching process. It was also observed that the diameters of the long fibers are decreased as the stretch ratios are increased.

In Experiment 4, thermogravimetric analysis (TGA) analyses according to the types of natural dyes according to Examples 1 and 8˜11 were performed.

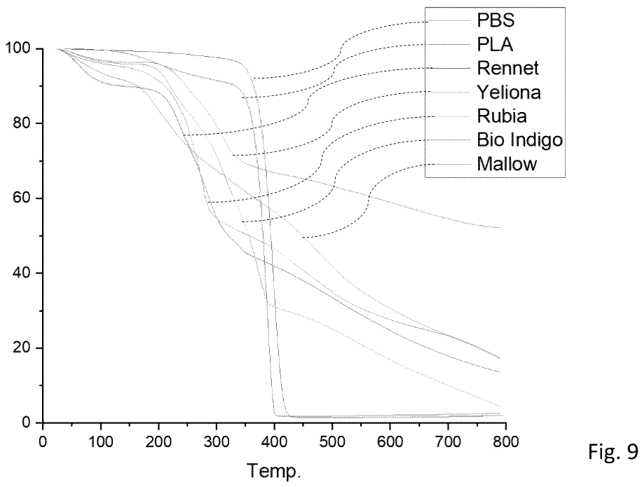

The TGA analyses according to the types of natural dyes according to Examples 1 and 8˜11 were performed, and the result was shown in FIG. 9.

Referring to FIG. 9, the weight change occurring at 30° C.˜100° C. is confirmed as moisture, and the PLA exists in the chip phase and 5 types of dyes exist in the powder phase, but in the powder phase, the surface area is large, so the change is also large.

Example 1 of Rubia has the highest melting point at 285° C., and it has been confirmed that it contains minerals and remains at 800° C. Indigo (Example 8), pomegranate (MALLOW, Example 9), and rennet (Example 11) are expected to have phase changes in the first phase at the same time in the evaporation of moisture at melting point peak 2 zones.

In addition, it can be seen that the basic carbonization point starts from almost 230° C. and drops rapidly, and from these results, it can be predicted that other polymer materials or nylon will not have the properties of natural dyes and will be carbonized during DOPE DYED.

However, as in the present disclosure, it can be expected that PLA polymers can retain their properties without carbonization even if natural dyes are applied.

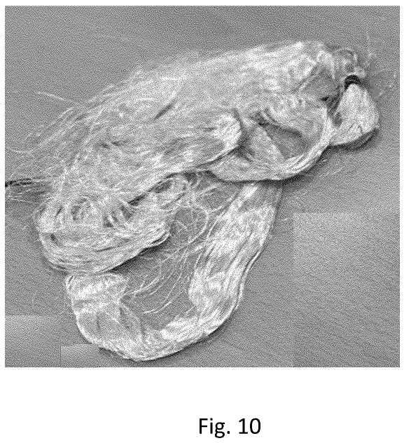

In Experiment 5, the PLA long fiber is produced by using rubia as the natural dye of Embodiment 1. As shown in FIG. 10, the yellow color of rubia is well mixed with polylactic acid and exists in the form of a masterbatch, and it is observed that the desired color expression was effectively achieved even when pure polylactic acid was added to it in the spinning process.

According to the above embodiments, the resources required for the dyeing process can be minimized, and the sensitivity of the fibers can be improved through a multi-stage hot-drawing process to maximize mechanical performance. In addition, in the present disclosure, a natural dye that does not contain chemical components is included in polylactic acid, which is a biodegradable material, and by producing fibers, it is harmless to the human body, and it has an environmentally advantageous effect because it will be ultimately biodegraded without leaving the problem of disposal.

1. A biodegradable polylactic acid high-strength long fiber with a natural dye applied, wherein the biodegradable polylactic acid high-strength long fiber is dyed in a spinning process by adding a masterbatch that is produced by adding the natural dye into a polylactic acid.

2. The biodegradable polylactic acid high-strength long fiber of claim 1, wherein a pure polylactic acid is added in a spinning process.

3. The biodegradable polylactic acid high-strength long fiber of claim 1, wherein a concentration of the natural dye is 1% to 5% by weight of a total polylactic acid.

4. The biodegradable polylactic acid high-strength long fiber of claim 1, wherein an average particle size of the natural dye is 3.0 μm or less.

5. The biodegradable polylactic acid high-strength long fiber of claim 1, wherein a polylactic acid resin is maintained below 100 ppm in the masterbatch.

6. The biodegradable polylactic acid high-strength long fiber of claim 1, wherein
the natural dye is one or a combination of bio indigo from an indigo extract, pomegranate, bee from center of the thorn tree, leafy vegetable extract, carel being a fruit of a Gaja tree, rennet from pear tree, rubia from a root and underground stem of a rake stem, Nimbus, or Yeliona from hydrangea in bright yellow color.

7. A method of manufacturing a biodegradable polylactic acid high-strength long fiber, the method comprising:
a first step of compounding a masterbatch by dispersing natural dye into in polylactic acid (PLA);
a second step of spinning a fiber from the master batch in a high-speed melt spinning device; and
a third step of heat stretching the spun fiber in a multi-stage stretching device.

8. The method of manufacturing the biodegradable polylactic acid high-strength long fiber according to claim 7, wherein the natural dye is compounded in the first step at a concentration of 5 to 15% by weight.

9. The method of manufacturing the biodegradable polylactic acid high-strength long fiber according to claim 7, wherein a twin-screw extruder is used in the first step of compounding the master batch.

10. The method of manufacturing the biodegradable polylactic acid high-strength long fiber according to claim 7, wherein the second step further comprises
adding pure polylactic acid so as to dilute the concentration of the natural dye into 1 to 58 by weight with respect to a total weight of the polylactic acid.

11. The method of manufacturing the biodegradable polylactic acid high-strength long fiber according to claim 7,
wherein stretching conditions in the multi-stage stretching device include a stretching ratio of 1.5 to 3 times, a speed of 2,000˜5,000 mpm/min, and a temperature 60 to 150° C.

12. The method of manufacturing the biodegradable polylactic acid high-strength long fiber according to claim 7, the method further comprising
an annealing process at an temperature of 90 to 140° C. after the heat stretching.
